(19) United States
(12) Patent Application Publication
(10) Pub. No.: US 2016/0141596 A1
(43) Pub. Date: May 19, 2016

(54) METHOD OF PRE-LITHIATING NEGATIVE ELECTRODE

(71) Applicant: LG CHEM, LTD., Seoul (KR)

(72) Inventors: In Sung Uhm, Daejeon (KR); Je Young Kim, Daejeon (KR); Seok Koo Kim, Daejeon (KR); Ji Yoon Kwon, Daejeon (KR); Hoe Jin Hah, Daejeon (KR); Sei Woon Oh, Daejeon (KR)

(73) Assignee: LG Chem, Ltd., Seoul (KR)

(21) Appl. No.: 14/890,222

(22) PCT Filed: Jun. 11, 2014
(86) PCT No.: PCT/KR2014/005108

§ 371 Date: Nov. 10, 2015

(30) Foreign Application Priority Data
Jul. 30, 2013 (KR) 10-2013-0090181

(51) Int. Cl. H01M 4/04; H01M 10/0525; H01M 4/587; H01M 4/58; H01M 10/0568; H01M 10/0569; H01M 10/0567; H01M 4/66; H01M 4/38

(52) U.S. Cl. CPC H01M 4/0404; H01M 4/661; H01M 10/0525; H01M 4/587; H01M 4/386; H01M 10/0568; H01M 10/0569; H01M 10/0567; H01M 4/5825; H01M 4/582; H01M 2300/0028; H01M 2220/20

(57) ABSTRACT

Disclosed is a method of pre-lithiating a negative electrode. More particularly, provided is a method of pre-lithiating a negative electrode, a surface of the negative electrode being lithiated by submerging a roll that is formed by rolling together a negative electrode, and copper (Cu) foil, both sides of which are rolled with metallic lithium (Li), in an electrolyte solution.

### TECHNICAL FIELD

The present invention relates to a method of pre-lithiating a negative electrode.

### BACKGROUND ART

As mobile device technology continues to develop and demand therefor continues to increase, demand for secondary batteries as energy sources is rapidly increasing. Among these secondary batteries, lithium secondary batteries which have high energy density and voltage and exhibit long lifespan and low self-discharge rate are commercially available and widely used.

Since conventional lithium secondary batteries use a compound, into which lithium such as LiCoO₂, LiMn₂O₄, etc. is inserted, as a positive electrode, the batteries are manufactured using carbon electrode not including lithium as a negative electrode. In carbon electrodes, a passive film is formed on a surface of a carbon electrode during initial charge. The film inhibits decomposition reaction by disturbing so that the organic solvent is not inserted between carbon lattice layers, and thus, may be used as a negative electrode for lithium secondary batteries by stabilizing a carbon structure and by improving reversibility of the carbon electrode. However, since such film formation reaction is irreversible, consumption of lithium ions is caused, decreasing a battery capacity. In addition, since charge and discharge efficiencies of carbon electrodes and positive electrodes are not 100%, consumption of lithium ions occurs as the number of cycles increases, and thus, electrode capacities are decreased, whereby cycle lifespan is finally decreased.

In this regard, when a pre-lithiated carbon electrode is used as a negative electrode, a high-capacity lithium secondary battery may be manufactured without capacity reduction due to film formation reaction, which was previously performed, exhibited during initial charge. In addition, since consumption of lithium ions exhibited according to an increasing cycle number is filled, cycle lifespan may be dramatically improved.

Accordingly, research into methods of pre-lithiating the carbon electrode is actively underway. Representatively, methods of preparing an electrode after lithiating a carbon active material through physicochemical methods, methods of electrochemically pre-lithiating a carbon electrode, etc are considered.

However, since physicochemical methods are methods of impregnating a negative electrode with lithium by passing lithium foil and a negative electrode between an upper roll and a lower roll to roll the same, the methods have risks such as fire and explosion due to environmental factors such as performance at high temperature.

On the other hand, since electrochemical methods are carried out at room temperature, risks such as fire and explosion are lower than physicochemical methods. However, processes of the electrochemical methods are complicated and difficult.

In addition, conventional pre-lithiating methods have advantages such as a dramatically low process speed, difficult lithium removal caused by rolling lithium foil with a negative electrode, and difficulty in recycling.

Furthermore, since, in conventional pre-lithiating methods, impregnation of a negative electrode with lithium is performed only when lithium foil and a negative electrode pass through between an upper roll and a lower roll, it is difficult to control reaction amounts and there is high probability of uncharged lithium.

Therefore, there is an urgent need for technology to resolve such problems.

### DISCLOSURE

### Technical Problem

The present invention has been made to solve the above and other technical problems that have yet to be resolved.

As a result of a variety of extensive and intensive studies and experiments, the inventors of the present invention developed a method of pre-lithiating a negative electrode, in which production efficiency may be increased by reducing a process time and complete recycling of lithium is possible, thus completing the present invention.

### Technical Solution

In accordance with one aspect of the present invention, provided is a method of pre-lithiating a negative electrode, wherein a surface of the negative electrode is lithiated by submerging a roll formed by rolling together a negative electrode, and copper (Cu) foil, both sides of which are rolled with metallic lithium (Li), in an electrolyte solution.

A stabilization process may be performed such that, after the lithiating, a stable film is formed on the negative electrode surface.

Compactness of the film may be controlled by roll submergence time in the electrolyte solution, temperature, and ionic conductivity of the electrolyte solution.

The roll submergence time in the electrolyte solution may be 1 to 240 hours.

The temperature may be −10° C. to 70° C.

The ionic conductivity of the electrolyte solution may be 10⁻⁴ S/cm to 10⁻¹ S/cm.

The stabilization process is performed for 0.1 to 72 hours at −10° C. to 70° C.

The negative electrode may include a carbon-based material, and/or Si as a negative electrode active material.

The carbon-based material may be at least one selected from the group consisting of artificial crystalline graphite, natural crystalline graphite, amorphous hard carbon, low-crystalline soft carbon, carbon black, acetylene black, Ketjen black, Super-P, graphene and fibrous carbon.

The carbon-based material may be artificial crystalline graphite, and/or natural crystalline graphite.

The electrolyte solution may include a lithium salt and a non-aqueous solvent.

The lithium salt may be at least one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium and lithium tetraphenyl borate.

The non-aqueous solvent may be a carbonate-based solvent and/or an ester-based solvent.

The electrolyte solution may further include an additive.

The additive may be at least one selected from the group consisting of vinylene carbonate, vinylethylene carbonate, fluoroethyl carbonate, salicylic acid, LiBF₄, LITFSL, LiBOB and LiODFB.

The present invention provides a lithiated negative electrode manufactured by the method of pre-lithiating the negative electrode.

The present invention provides a secondary battery including an electrode assembly, which includes the lithiated negative electrode according to claim 16, a positive electrode, and a separator disposed between the lithiated negative electrode and the positive electrode, impregnated with an electrolyte solution.

The positive electrode includes a lithium transition metal oxide represented by Formula 1 or 2 below as a positive electrode active material:

LiₓM_{y}Mn_{2-y}O_{4-z}A_{z} (1),

wherein M is at least one element selected from the group consisting of Al, Mg, Ni, Co, Fe, Cr, V, Ti, Cu, B, Ca, Zn, Zr, Nb, Mo, Sr, Sb, W, Ti and Bi;

A is at least one monovalent or divalent anion; and

0.9≦x≦1.2, 0<y<2, and 0≦z<0.2,

(1-x)LiM′O_{2-y}A_{y}-xLi₂MnO_{3-y′}A_{y′} (2),

wherein M′ is MnaMb;

M is at least one selected from the group consisting of Ni, Ti, Co, Al, Cu, Fe, Mg, B, Cr, Zr, Zn and Period II transition metals;

A is at least one selected from the group consisting of anions such as PO₄, BO₃, CO₃, F and NO₃; and

0<x<1, 0<y≦0.02, 0<y′≦0.02, 0.5≦a≦1.0, 0≦b≦0.5, and a+b=1.

The secondary battery may be a lithium ion battery, a lithium ion polymer battery or a lithium polymer battery.

The present invention provides a battery module including the secondary battery as a unit cell, a battery pack including the battery module and a device including the battery pack as a power source.

The device may be an electric vehicle, a hybrid electric vehicle, a plug-in hybrid electric vehicle, or a system for storing power.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 3 are schematic views illustrating a method of pre-lithiating a negative electrode according to an embodiment of the present invention.

### MODE FOR INVENTION

Now, the present invention will be described in more detail with reference to the accompanying drawings. These examples are provided for illustrative purposes only and should not be construed as limiting the scope and spirit of the present invention.

As described above, according to a method of pre-lithiating a negative electrode according to the present invention, a surface of the negative electrode is lithiated by submerging a roll formed by rolling together a negative electrode, and copper (Cu) foil, both sides of which are rolled with metallic lithium (Li), in an electrolyte solution. The inventors of the present application confirmed that, by submerging the roll, which is formed by rolling together the negative electrode and copper (Cu) foil, in an electrolyte solution to lithiate a surface of the negative electrode, a lithium foil is completely separated from the negative electrode to recycle the same without a separation process, whereby efficiency may be increased by reducing a process time, a reaction amount of lithium may be easily controlled, irreversibility of the negative electrode is improved through the process, cell capacity is increased, and charge and discharge efficiency of a battery is increased. Accordingly, the present inventors confirmed that battery lifespan may be improved.

In a specific embodiment, after the lithiating, a stabilization process may be carried out such that a stable film is formed on the surface of the negative electrode. Accordingly, compactness of the film formed through the stabilization process may be controlled by roll submergence time in the electrolyte solution, temperature, and ionic conductivity of the electrolyte solution.

In this case, the roll submergence time in the electrolyte solution may be 1 to 240 hours, the temperature may be −10° C. to 70° C., and the ionic conductivity of the electrolyte solution may be 10⁻⁴ S/cm to 10⁻¹ S/cm.

Accordingly, the stabilization process may be performed for 0.1 to 72 hours at −10° C. to 70° C.

In a specific embodiment, the negative electrode includes a carbon-based material, and/or Si as a negative electrode active material.

In this case, the carbon-based material may be at least one selected from the group consisting of artificial crystalline graphite, natural crystalline graphite, amorphous hard carbon, low-crystalline soft carbon, carbon black, acetylene black, Ketjen black, Super-P, graphene and fibrous carbon, preferably artificial crystalline graphite and/or natural crystalline graphite.

In general, the negative electrode is prepared by drying after coating a mixture of a negative electrode active material, a conductive material and a binder, as an electrode mixture, on a positive electrode current collector. In this case, as desired, the mixture may further include a filler.

The negative electrode active material may include, in addition to the materials, metal composite oxides such as LiₓFe₂O₃ where 0≦x≦1, LiₓWO₂ where 0≦x≦1, SnₓMe₁₋ₓMe′_{y}O_{z} where Me: Mn, Fe, Pb, or Ge; Me′: Al, B, P, Si, Group I, II and III elements, or halogens; 0<x≦1; 1≦y≦3; and 1≦z≦8; lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni-based materials; titanium oxides; lithium titanium oxides; and the like, particularly carbon-based materials and/or Si.

The negative electrode current collector is typically fabricated to a thickness of 3 to 500 μm. The negative electrode current collector is not particularly limited so long as it does not cause chemical changes in the fabricated battery and has conductivity. For example, the negative electrode current collector may be made of copper, stainless steel, aluminum, nickel, titanium, sintered carbon, copper or stainless steel surface-treated with carbon, nickel, titanium, or silver, and aluminum-cadmium alloys. Similar to the positive electrode current collector, the negative electrode current collector may also have fine irregularities at a surface thereof to enhance adhesion between the negative electrode current collector and the negative electrode active material and may be used in various forms including films, sheets, foils, nets, porous structures, foams, and non-woven fabrics.

The conductive material is generally added in an amount of 1 to 50 wt % based on the total weight of a mixture including a positive electrode active material. There is no particular limit as to the conductive material, so long as it does not cause chemical changes in the fabricated battery and has conductivity. For example, graphite such as natural or artificial graphite; carbon black such as carbon black, acetylene black, Ketjen black, channel black, furnace black, lamp black, and thermal black; conductive fibers such as carbon fibers and metallic fibers; metallic powders such as carbon fluoride powder, aluminum powder, and nickel powder; conductive whiskers such as zinc oxide whiskers and potassium titanate whiskers; conductive metal oxides such as titanium oxide; conductive materials such as polyphenylene derivatives; and the like may be used.

Meanwhile, the graphite-based material having elasticity may be used as the conductive material and may be used with the other materials.

The binder is a component assisting in binding between an active material and the conductive material and in binding of the active material to a current collector. The binder is typically added in an amount of 1 to 50 wt % based on the total weight of the mixture including the positive electrode active material. Examples of the binder include, but are not limited to, polyvinylidene fluoride, polyvinyl alcohols, carboxymethylcellulose (CMC), starch, hydroxypropylcellulose, regenerated cellulose, polyvinyl pyrrolidone, tetrafluoroethylene, polyethylene, polypropylene, ethylene-propylene-diene terpolymer (EPDM), sulfonated EPDM, styrene butadiene rubber, fluorine rubber, and various copolymers.

The filler is optionally used as a component to inhibit positive electrode expansion. The filler is not particularly limited so long as it is a fibrous material that does not cause chemical changes in the fabricated battery. Examples of the filler include olefin-based polymers such as polyethylene and polypropylene; and fibrous materials such as glass fiber and carbon fiber.

Meanwhile, the electrolyte solution may include a lithium salt and a non-aqueous solvent.

In this case, the lithium salt may be at least one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium and lithium tetraphenyl borate. The non-aqueous solvent may be a carbonate-based solvent and/or an ester-based solvent.

The electrolyte solution may further include an additive. Accordingly, the additive may be at least one selected from the group consisting of vinylene carbonate, vinylethylene carbonate, fluoroethyl carbonate, salicylic acid, LiBF₄, LITFSL, LiBOB and LiODFB.

The present invention provides a lithiated negative electrode manufactured according to the method of pre-lithiating the negative electrode.

In addition, the present invention provides a secondary battery including an electrode assembly that includes the lithiated negative electrode, a positive electrode, and a separator disposed between the lithiated negative electrode and the positive electrode, which are impregnated with an electrolyte solution. Accordingly, the secondary battery may be a lithium ion battery, a lithium ion polymer battery or a lithium polymer battery.

In general, lithium secondary batteries included a positive electrode, a negative electrode, a separator disposed between the positive electrode and the negative electrode, and a lithium salt-containing non-aqueous electrolyte. Other components of lithium secondary batteries are described below.

The positive electrode is manufactured by coating, drying and pressing the positive electrode active material on a positive electrode collector. As needed, the positive electrode may selectively, further include a conductive material, a binder, a filler, etc.

The positive electrode may further include a lithium transition metal oxide represented by Formula 1 or 2 below as a positive electrode active material.

LiₓM_{y}Mn_{2-y}O_{4-z}A_{z} (1)

wherein M is at least one element selected from the group consisting of Al, Mg, Ni, Co, Fe, Cr, V, Ti, Cu, B, Ca, Zn, Zr, Nb, Mo, Sr, Sb, W, Ti and Bi;

A is at least one monovalent or divalent anion; and

0.9≦x≦1.2, 0<y<2, and 0≦z<0.2.

(1-x)LiM′O_{2-y}A_{y}-xLi₂MnO_{3-y′}A_{y′} (2)

wherein M′ is MnaMb;

M is at least one selected from the group consisting of Ni, Ti, Co, Al, Cu, Fe, Mg, B, Cr, Zr, Zn and Period II transition metals;

A is at least one selected from the group consisting of anions such as PO₄, BO₃, CO₃, F and NO₃; and

0<x<1, 0<y≦0.02, 0<y′≦0.02, 0.5≦a≦1.0, 0≦b≦0.5, and a+b=1.

Examples of the positive electrode active material may include, in addition to the lithium transition metal oxide represented by Formula 1 or 2 below, may include layered compounds such as lithium cobalt oxide (LiCoO₂) and lithium nickel oxide (LiNiO₂) or compounds substituted with one or more transition metals; lithium manganese oxides represented by Li₁₋ₓMn₂₋ₓO₄ where 0≦x≦0.33, such as LiMnO₃, LiMn₂O₃, and LiMnO₂; lithium copper oxide (Li_{2 C}uO₂); vanadium oxides such as LiV₃O₈, LiV₃O₄, V₂O₅, and Cu₂V₂O₇; Ni-site type lithium nickel oxides having the formula LiNi₁₋ₓMₓO₂ where M=Co, Mn, Al, Cu, Fe, Mg, B, or Ga, and 0.01≦x≦0.3; lithium manganese composite oxides having the formula LiMn₂₋ₓMₓO₂ where M=Co, Ni, Fe, Cr, Zn, or Ta, and 0.01≦x≦0.1 or the formula Li₂Mn₃MO₈ where M=Fe, Co, Ni, Cu, or Zn; spinel-structure lithium manganese composite oxides represented by LiNiₓMn₂₋ₓO₄; LiMn₂O₄ where some of the Li atoms are substituted with alkaline earth metal ions; disulfide compounds; Fe₂(MoO₄)₃; and the like, but embodiments of the present invention are not limited thereto.

The positive electrode current collector is generally fabricated to a thickness of 3 to 500 μm. The positive electrode current collector is not particularly limited so long as it does not cause chemical changes in the fabricated lithium secondary battery and has high conductivity. For example, the positive electrode current collector may be made of stainless steel, aluminum, nickel, titanium, sintered carbon, aluminum or stainless steel surface-treated with carbon, nickel, titanium, or silver, or the like. The positive electrode current collector may have fine irregularities at a surface thereof to increase adhesion between the positive electrode active material and the positive electrode current collector. In addition, the positive electrode current collector may be used in any of various forms including films, sheets, foils, nets, porous structures, foams, and non-woven fabrics.

The separator is disposed between the positive electrode and the negative electrode and, as the separator, a thin insulating film with high ion permeability and high mechanical strength is used. The separator generally has a pore diameter of 0.01 to 10 μm and a thickness of 5 to 300 μm. As the separator, for example, sheets or non-woven fabrics, made of an olefin-based polymer such as polypropylene; or glass fibers or polyethylene, which have chemical resistance and hydrophobicity, are used. When a solid electrolyte such as a polymer or the like is used as an electrolyte, the solid electrolyte may also serve as a separator.

The lithium salt-containing non-aqueous electrolyte consists of a non-aqueous electrolyte and lithium. As the non-aqueous electrolyte, a non-aqueous organic solvent, an organic solid electrolyte, an inorganic solid electrolyte or the like may be used, but the present invention is not limited thereto.

Examples of the non-aqueous organic solvent include non-aprotic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte include polyethylene derivatives, polyethylene oxide derivatives, polypropylene oxide derivatives, phosphoric acid ester polymers, polyagitation lysine, polyester sulfide, polyvinyl alcohols, polyvinylidene fluoride, and polymers containing ionic dissociation groups.

Examples of the inorganic solid electrolyte include, but are not limited to, nitrides, halides and sulfates of lithium (Li) such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂

The lithium salt is a material that is readily soluble in the non-aqueous electrolyte and examples thereof include, but are not limited to, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium tetraphenyl borate, and imides

In addition, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the lithium salt-containing non-aqueous electrolyte. If necessary, in order to impart incombustibility, the electrolyte may further include halogen-containing solvents such as carbon tetrachloride and ethylene trifluoride. Further, in order to improve high-temperature storage characteristics, the non-aqueous electrolyte may further include carbon dioxide gas, and fluoro-ethylene carbonate (FEC), propene sultone (PRS) and the like may be further included.

In one specific embodiment, a lithium salt-containing non-aqueous electrolyte may be prepared by adding a lithium salt such as LiPF₆, LiClO₄, LiBF₄, LiN(SO_{2 C}F₃)₂, or the like to a mixed solvent including EC or PC, which is a high dielectric solvent and a cyclic carbonate, and DEC, DMC, or EMC, which is a low viscosity solvent and a linear carbonate.

The present invention provides a battery module including the secondary battery as a unit cell, a battery pack including the battery module and a device including the battery pack as a power source.

In this regard, specific examples of the device include, but are not limited to, an electric vehicle, a hybrid electric vehicle, a plug-in hybrid electric vehicle, or a system for storing power.

Now, the present invention will be described in more detail with reference to the following examples. These examples are provided only for illustration of the present invention and should not be construed as limiting the scope and spirit of the present invention.

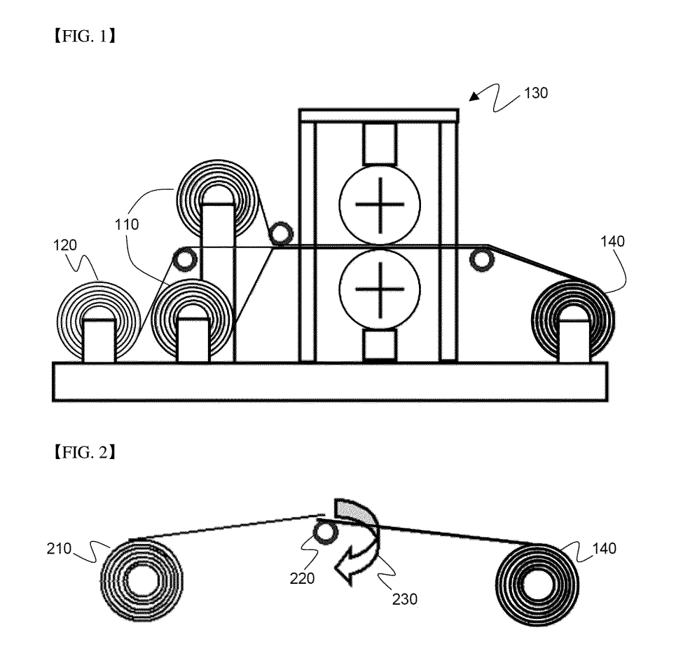

FIGS. 1 to 3 are schematic views illustrating a method of pre-lithiating a negative electrode according to an embodiment of the present invention.

FIG. 1 illustrates a schematic view that represents a method of rolling both sides of copper (Cu) foil 120 with metal lithiums 110 before pre-lithiating the negative electrode according to an embodiment of the present invention.

The copper (Cu) foil 120 is disposed between the upper and lower metal lithiums 110 before pre-lithiating the negative electrode. Copper (Cu) foil 140, both sides of which are rolled with metal lithium, is prepared by passing between two rolls 130.

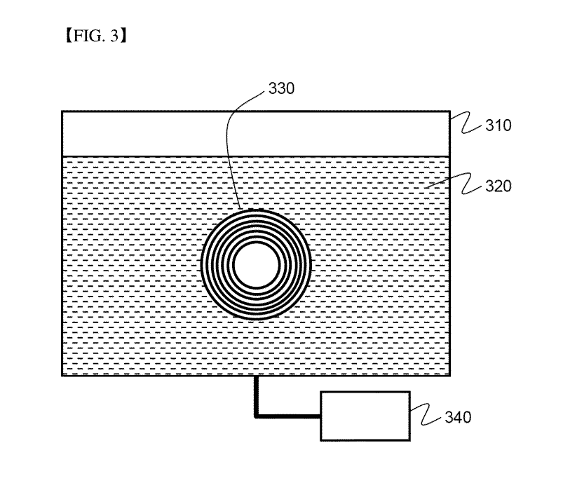

Referring to FIG. 2, by locating (230) both sides of the copper (Cu) foil 140, which are rolled with metallic lithium prepared as illustrated in FIG. 1, with a negative electrode 210 in one direction using a roll 220, a roll formed by rolling together the copper (Cu) foil 140, both sides of which are rolled with the metal lithium, and the negative electrode 210 is manufactured.

Referring to FIG. 3, a surface of a negative electrode roll 330 is lithiated by submerging a negative electrode roll 330, which is formed by rolling the negative electrode and the copper (Cu) foil as illustrated in FIG. 2, in an electrolyte solution 320 within a water tank 310.

In this case, since a predetermined temperature controller is electrically connected to the water tank, compactness of the film formed on the surface of the negative electrode may be controlled by controlling temperature of the electrolyte solution within the water tank.

In addition, compactness of the film formed on the surface of the negative electrode may be controlled by adjusting, in addition to the temperature, conditions such as roll submergence time in the electrolyte solution, ionic conductivity of the electrolyte solution, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, by submerging the roll, which is formed by rolling together the negative electrode and copper (Cu) foil, in an electrolyte solution to lithiate a surface of the negative electrode according to a method of pre-lithiating a negative electrode of the present invention, a lithium foil is completely separated from the negative electrode to recycle the same without a separation process, whereby efficiency may be increased by reducing a process time, an reaction amount of lithium may be easily controlled, irreversibility of the negative electrode is improved through the process, cell capacity is increased, and charge and discharge efficiency of a battery is increased. Accordingly, the present inventors confirmed that battery lifespan may be improved.

1. A method of pre-lithiating a negative electrode, wherein a surface of the negative electrode is lithiated by submerging a roll formed by rolling together a negative electrode, and copper (Cu) foil, both sides of which are rolled with metallic lithium (Li), in an electrolyte solution.

2. The method according to claim 1, wherein a stabilization process is performed such that, after the lithiating, a stable film is formed on the negative electrode surface.

3. The method according to claim 2, wherein compactness of the film is controlled by roll submergence time in the electrolyte solution, temperature, and ionic conductivity of the electrolyte solution.

4. The method according to claim 3, wherein the roll submergence time in the electrolyte solution is 1 to 240 hours.

5. The method according to claim 3, wherein the temperature is −10° C. to 70° C.

6. The method according to claim 3, wherein the ionic conductivity of the electrolyte solution is 10⁻⁴ S/cm to 10⁻¹ S/cm.

7. The method according to claim 2, wherein the stabilization process is performed for 0.1 to 72 hours at −10° C. to 70° C.

8. The method according to claim 1, wherein the negative electrode comprises a carbon-based material, and/or Si as a negative electrode active material.

9. The method according to claim 8, wherein the carbon-based material is at least one selected from the group consisting of artificial crystalline graphite, natural crystalline graphite, amorphous hard carbon, low-crystalline soft carbon, carbon black, acetylene black, Ketjen black, Super-P, graphene and fibrous carbon.

10. The method according to claim 9, wherein the carbon-based material is artificial crystalline graphite, and/or natural crystalline graphite.

11. The method according to claim 1, wherein the electrolyte solution comprises a lithium salt and a non-aqueous solvent.

12. The method according to claim 11, wherein the lithium salt is at least one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium and lithium tetraphenyl borate.

13. The method according to claim 11, wherein the non-aqueous solvent is a carbonate-based solvent and/or an ester-based solvent.

14. The method according to claim 11, wherein the electrolyte solution further comprises an additive.

15. The method according to claim 14, wherein the additive is at least one selected from the group consisting of vinylene carbonate, vinylethylene carbonate, fluoroethyl carbonate, salicylic acid, LiBF₄, LITFSL, LiBOB and LiODFB.

16. A lithiated negative electrode manufactured by the method according to claim 1.

17. A secondary battery comprising an electrode assembly that comprises the lithiated negative electrode according to claim 16, a positive electrode, and a separator disposed between the lithiated negative electrode and the positive electrode, impregnated with an electrolyte solution.

18. The secondary battery according to claim 17, wherein the positive electrode comprises a lithium transition metal oxide represented by Formula 1 or 2 below as a positive electrode active material:
LiₓM_{y}Mn_{2-y}O_{4-z}A_{z} (1),
wherein M is at least one element selected from the group consisting of Al, Mg, Ni, Co, Fe, Cr, V, Ti, Cu, B, Ca, Zn, Zr, Nb, Mo, Sr, Sb, W, Ti and Bi;
A is at least one monovalent or divalent anion; and
0.9≦x≦1.2, 0<y<2, and 0≦z<0.2,
(1-x)LiM′O_{2-y}A_{y}-xLi₂MnO_{3-y′}A_{y′} (2),
wherein M′ is MnₐM_{b};
M is at least one selected from the group consisting of Ni, Ti, Co, Al, Cu, Fe, Mg, B, Cr, Zr, Zn and Period II transition metals;
A is at least one selected from the group consisting of anions such as PO₄, BO₃, CO₃, F and NO₃; and
0<x<1, 0<y≦0.02, 0<y′≦0.02, 0.5≦a≦1.0, 0≦b≦0.5, and a+b=1.

19. The secondary battery according to claim 17, wherein the secondary battery is a lithium ion battery, a lithium ion polymer battery or a lithium polymer battery.

20. A battery module comprising the secondary battery according to claim 17 as a unit cell.

21. A battery pack comprising the battery module according to claim 20.

22. A device comprising the battery pack according to claim 21 as a power source.

23. The device according to claim 22, wherein the device is an electric vehicle, a hybrid electric vehicle, a plug-in hybrid electric vehicle or a system for storing power.
